(19) United States
(12) Patent Application Publication
(10) Pub. No.: US 2018/0353802 A1
(43) Pub. Date: Dec. 13, 2018

(54) Sporting towel mat for use on a support surface

(71) Applicant: Grounding Inc., Tortola (VG)

(72) Inventor: Victor Tsai, Taipei City (TW)

(21) Appl. No.: 15/998,502

(22) Filed: Aug. 16, 2018

Related U.S. Application Data
(63) Continuation-in-part of application No. 14/943,958, filed on Nov. 17, 2015.

(30) Foreign Application Priority Data
Sep. 16, 2015 (TW) 104130586

(51) Int. Cl. A63B 21/00; B32B 3/26; B32B 25/10; B32B 25/20

(52) U.S. Cl. CPC A63B 21/4037; B32B 3/26; A63B 2071/0694; B32B 25/20; B32B 25/10

(57) ABSTRACT

A sporting towel mat for use on a support surface includes a fabric layer defining a first surface and a second surface, and only one single first anti-slip strip and only one single second anti-slip strip having a predetermined with and being attached on the first surface and the second surface respectively. The first anti-slip strip and the second anti-slip strip covers the first surface and second surface of the fabric towel incompletely so that the first surface and the second surface of the fabric towel has at least one part thereof exposed to form at least one first exposed part and at least one second exposed part respectively. The fabric towel is foldable with said first anti-slip strip and said second anti-slip strip.

### CROSS-REFERENCE TO RELATED APPLICATION

This application is a Continuation-in-Part of co-pending application Ser. No. 14/943,958 filed on 17 Nov. 2015, for which priority is claimed under 35 U.S.C. § 120; and this application claims priority of Application No. 104130586 filed in TAIWAN on 16 Sep. 2015 under 35 U.S.C. § 119, the entire contents of all are hereby incorporated by reference.

### BACKGROUND OF THE INVENTION

### 1. Field of the Invention

The present invention relates to sporting towel mats, and more particularly, to a sporting towel mat for use on a support surface.

### 2. Description of the Related Art

A conventional sporting towel mat, such as a double-sided anti-slip towel mat disclosed in Taiwan Patent Pub. No. 201442676, includes a fabric layer and two anti-slip layers respectively attached on two sides of the fabric layer in a way that the two sides of the fabric layer are partially exposed. By means of the anti-slip layers and the exposed parts of the fabric layer, the conventional sporting towel mat has an anti-slip effect on the user's skin no matter there is sweat on the skin or not, that hereinafter called dry and wet anti-slip effect. It is well-known that when there is sweat on the human skin, such as the skin of the palm, the fabric surface has the anti-slip effect on the skin, but the anti-slip layer doesn't; in contrast, when there is no sweat on the skin, the anti-slip layer has the anti-slip effect on the skin, but the fabric surface doesn't. Therefore, the aforesaid conventional sporting towel mat has the dry and wet anti-slip effect. Besides, when the towel mat is in use, the top surface of the towel mat performs the anti-slip effect to the user contacting the top surface, and the bottom surface of the towel mat also performs the anti-slip effect to the ground or another mat under the towel mat by means of the anti-slip layer.

In another conventional towel mat, such as that disclosed in U.S. Patent Pub. No. 2005/0003173, a plurality of discrete anti-slip projections are disposed on one side or two sides of a fabric layer, so that the towel mat has the dry and wet anti-slip effect. However, because of the discrete anti-slip projections, the user when touching the surface of the towel mat may feel the surface is uneven, thereby feeling uncomfortable in sense of touch. In addition, because the anti-slip projections are arranged discretely, a large portion of the fabric layer is exposed to the outside, resulting in an insufficient anti-slip effect on the skin without sweat. When the towel mat is used in a way that the surface with the anti-slip projections faces downward to the ground, the user can't be sure whether there is the anti-slip projection at the part of the towel mat pressed by the palm or other parts of the body of the user; if there is not, the towel mat might be slipped and cause sport injuries to the user.

### SUMMARY OF THE INVENTION

The present invention has been accomplished under the circumstances in view. It is the main object of the present invention to provide a sporting towel mat for use on a support surface, which provides a continuous anti-slip strip, improving the comfort of the user's sense of touch.

It is another object of the present invention to provide a sporting towel mat for use on a support surface, wherein the anti-slip strip has an uneven surface, resulting in a relatively larger area of the anti-slip surface and a stereoscopic structure, so as to improve the anti-slip effect.

It is still another object of the present invention to provide a sporting towel mat for use on a support surface, which has a plurality of partial sections certainly including parts of both the anti-slip strip and a fabric towel, so that the sporting towel mat in use is ensured a great anti-slip effect.

To achieve these and other objects of the present invention, a sporting towel mat for use on a support surface comprises a fabric layer defining a first surface and a second surface, and a first anti-slip strip having a predetermined with and being attached on the first surface of the fabric towel to form a predetermined pattern that covers the first surface of the fabric towel incompletely so that the first surface of the fabric towel has at least one part thereof exposed to the outside of the first anti-slip strip to form at least one first exposed part. The first anti-slip strip is in a continuous form defining two relatively higher side parts and a relatively lower middle part, or two relatively lower side parts and a relatively higher middle part. The first surface of the fabric towel is defined with a plurality of partial sections where the at least one first exposed part and the first anti-slip strip are both partially included in any area equal to the area of the human palm excluding all fingers in each partial section.

In this way, the anti-slip strip of the present invention is continuous, which can improve touching comfort. Further, the anti-slip strip having an uneven surface design results in a relatively larger area of the anti-slip surface and a stereoscopic structure to improve the anti-slip effect.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a top view of a sporting towel mat in accordance with a first embodiment of the present invention.

FIG. 2 is a schematic sectional view of a part of the first embodiment of the present invention, illustrating the anti-slip strip attached on the fabric towel.

FIG. 3 is a top view of a sporting towel mat in accordance with a second embodiment of the present invention.

FIG. 4 is a partially cut-away perspective view of the second embodiment of the present invention, illustrating the anti-slip strip attached on the fabric towel.

FIG. 5 is a schematic sectional view of a part of the second embodiment of the present invention, illustrating the anti-slip strip attached on the fabric towel.

FIG. 6 is a top view of a sporting towel mat in accordance with a third embodiment of the present invention.

FIG. 7 is a top view of an alternate form of the third embodiment of the present invention, illustrating another arrangement of the anti-slip strip.

FIG. 8 is a schematic top view of a sporting towel mate in accordance with a fourth embodiment of the present invention, illustrating the pattern of a first anti-slip strip.

FIG. 9 is a schematic bottom view of the fourth embodiment of the present invention, illustrating the pattern of the second anti-slip strip.

FIG. 10 is a schematic sectional view of the fourth embodiment of the present invention.

### DETAILED DESCRIPTION OF THE INVENTION

The technical features of the present invention will be fully understood from the detailed description of preferred embodiments given herein below and the accompanying drawings.

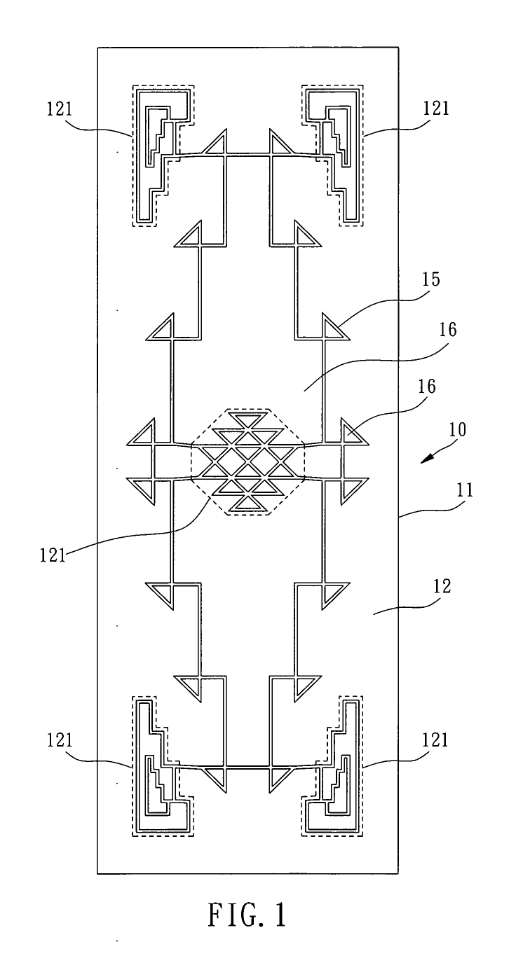

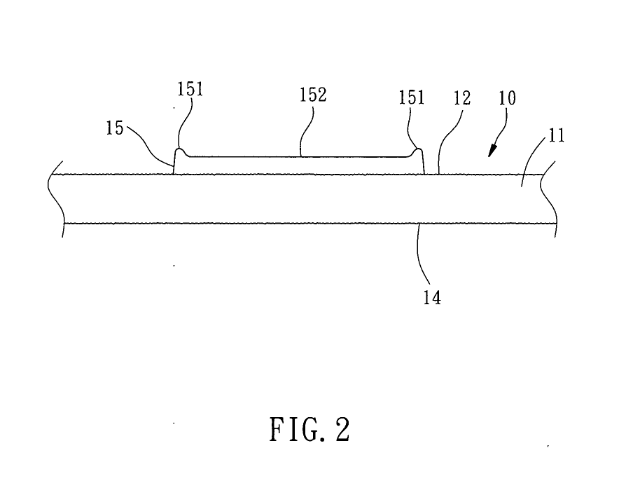

Referring to FIGS. 1 and 2, a sporting towel mat 10 according to a first preferred embodiment of the present invention includes a fabric towel 11 and an anti-slip strip 15.

The fabric towel 11 has a first surface 12 and a second surface 14.

The anti-slip strip 15 has a predetermined width and is attached on the first surface 12 of the fabric towel 11 to form a predetermined pattern which covers the first surface 12 of the fabric towel 11 incompletely, so that the first surface 12 of the fabric towel 11 has at least one exposed part 16 which is not covered by the anti-slip strip 15.

The anti-slip strip 15 is shaped in a continuous form, and has two side parts 151 and a middle part 152 located between the two side parts 151 and lower than the two side parts 151 on a surface of the anti-slip strip. In the first preferred embodiment, the middle part 152 of the anti-slip strip 15 has a thickness no more than 1 mm. For a towel mat, if the thickness of the anti-slip strip 15 is larger than 1 mm, the user is liable to feel the projection of the anti-slip strip 15 on the surface of the towel mat obviously, thereby feeling uncomfortable while using the towel mat. In practice, the thickness of the middle part 152 of the anti-slip strip 15 is optimal in the range from 0.2 mm to 0.3 mm, so that the anti-slip strip 15 with the preferred thickness has a nice flexibility and does not impact the bending, stacking and receiving of the towel mat. In addition, in the first embodiment, the primary constituent of the anti-slip strip is silicone rubber, but it is just an example, the present invention is not limited thereto. Alternatively, other conventional materials suitable for the anti-slip strip can be used to form the anti-slip strip 15 of the present invention.

The first surface 12 of the fabric towel 11 is defined with a plurality of partial sections 121. The at least one exposed part 16 and the anti-slip strip 15 are both partially included in any area equal to the area of the human palm excluding all fingers in each of the partial sections 121. The partial sections 121 can be arranged at the locations on the fabric towel 11, where the user's palms or foot soles will often touch while the user uses the towel mat, thereby achieving the dry and wet anti-slip effect.

In the first embodiment, the anti-slip strip 15 is interlaced to form a plurality of intersections, resulting in a plurality of exposed parts 16. In the first embodiment, except for the intersections, the other parts of the anti-slip strip 15 have the same width.

The main structure of the first embodiment is described in the above content, and the usage status of the first embodiment will be illustrated below.

Before in use, the sporting towel mat 10 of the present invention can be laid on a soft mat (not shown) in a way that the first surface 12 faces upwardly.

As shown in FIGS. 1 and 2, the user can do exercise, such as yoga, on the sporting towel mat 10 of the present invention. During the exercise, the palms or foot soles of the user often press on the first surface 12, especially the partial sections 121, and any area equal to the area of the human palm excluding all fingers in each partial section 121 certainly includes a portion of the exposed parts 16 and a portion of the anti-slip strip 15, so the arrangement of the anti-slip strip 15 provides the sporting towel mat 10 with the dry and wet anti-slip effect. Therefore, the user can feel relieved when doing exercise on the sporting towel mat 10 of the present invention without worrying that the palm or foot sole may slip, so that the sporting towel mat 10 is ensured a great anti-slip effect. In addition, the anti-slip strip 15 having the side parts 151 higher than the middle part results in a relatively larger area of the anti-slip surface and a stereoscopic structure of the anti-slip strip 15, that increases the contact area between the user's skin and the towel mat 10, so as to improve the anti-slip effect.

Even if the sporting towel mat 10 is used in a way that the first surface 12 faces downward to the ground and the user is in contact with the second surface 14, the aforesaid arrangement of the anti-slip strip 15 ensures the anti-slip strip 15 to be partially pressed by the user's palm or foot sole pressing on the second surface 14, resulting in anti-slip effect on another mat disposed under the sporting towel mat 10.

Because the anti-slip strip 15 of the present invention is shaped in a continuous form, the user does not feel the uncomfortableness caused by pressing multiple protrusions. Therefore, the towel mat of the present invention is more comfortable in sense of touch than the conventional towel mats.

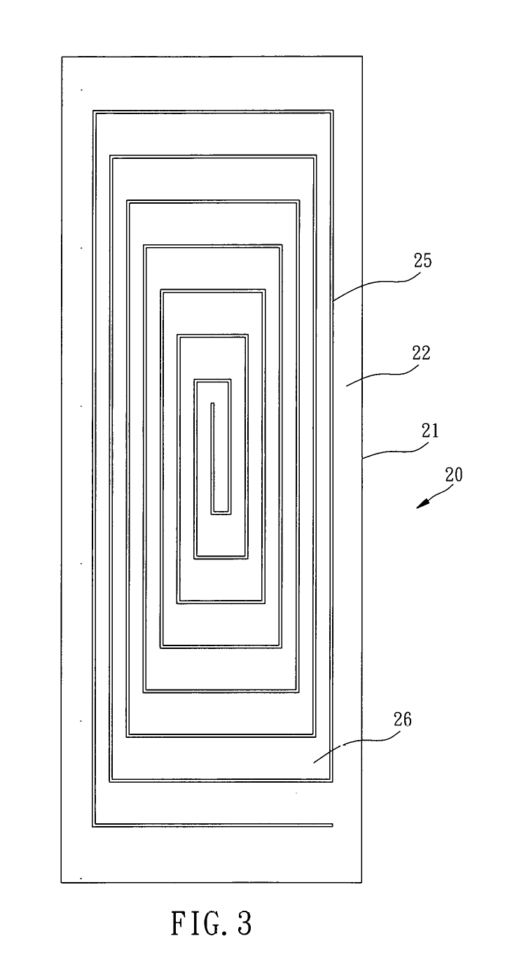

Referring to FIGS. 3-5, a sporting towel mat 20 having a continuous anti-slip strip 25 according to a second preferred embodiment of the present invention is similar to the sporting towel mat 10 of the first preferred embodiment, but differs from the sporting towel mat 10 in that described below.

The middle part 252 of the anti-slip strip 25 has a plurality of concave lines 253, so that the middle part 252 of the anti-slip strip 25 is uneven on the surface. The concave lines 253 can be shaped in various forms. For example, the concave lines 253 can be extended substantially along the extension direction of the anti-slip strip 25, extended perpendicularly to the extension direction of the anti-slip strip 25 in a multiple-section form, or arranged irregularly. As an example, the concave lines 253 are extended substantially along the extension direction of the anti-slip strip 25 in the second embodiment. The concave lines 253 increase the area of the surface of the anti-slip strip 25, thereby providing the sporting towel mat 20 with a relatively better anti-slip effect. Moreover, because the concave lines 253 are extended along the extension direction of the anti-slip strip 25, when the user's sweat is attached on the surface of the anti-slip strip 25, the concave lines can perform the capillary action so that the sweat can be transferred and dispersed along the concave lines 253, thereby evaporated quickly. In other words, the concave lines can make the wet surface of the anti-slip strip 25 dry faster and further improving the anti-slip effect.

In addition, in the second preferred embodiment, the middle part 252 of the anti-slip strip 25 further has a plurality of openings 254, and parts of the fabric towel 21 are exposed via the openings 254. In this way, when the user's sweat falls on the anti-slip strip 25, the sweat located at the openings 254 can be absorbed by the fabric towel 21, so that the sporting towel mat 20 can remove sweat quickly.

In addition, the anti-slip strip 25 can also include thermochromic material (not shown). The thermochromic material is a well-known material, and it is difficult to show the thermochromic material included in the anti-slip strip 25 by drawing, so the thermochromic material is unshown in the figures. When the user touches the anti-slip strip 25, the temperature of the anti-slip strip 25 is increased because of the user's body temperature, and the thermochromic material included in the anti-slip strip 25 changes color according to the temperature variation, resulting in more interest to the towel mat in the sense of sight.

It should be noted that the middle part 252 of the anti-slip strip 25 can just has irregular unevenness on the surface, instead of the aforesaid concave lines extended along the extension direction of the anti-slip strip 25, and also have a relatively larger area of the anti-slip surface and irregular pattern.

As shown in FIG. 3, the anti-slip strip 25 in the second preferred embodiment is a single strip without any intersection, resulting in only one exposed part 26. The exposed part 26 and the anti-slip strip 25 are both certainly included in any area equal to the area of the human palm excluding all fingers on the first surface 22 of the fabric towel 21. Therefore, no matter where the user's palm or foot sole touch on the first surface 22, the sporting towel mat 20 of the present invention can provide the dry and wet anti-slip effect.

Other structures and effects of the second referred embodiment are the same with that of the first preferred embodiment, so their detailed description is omitted.

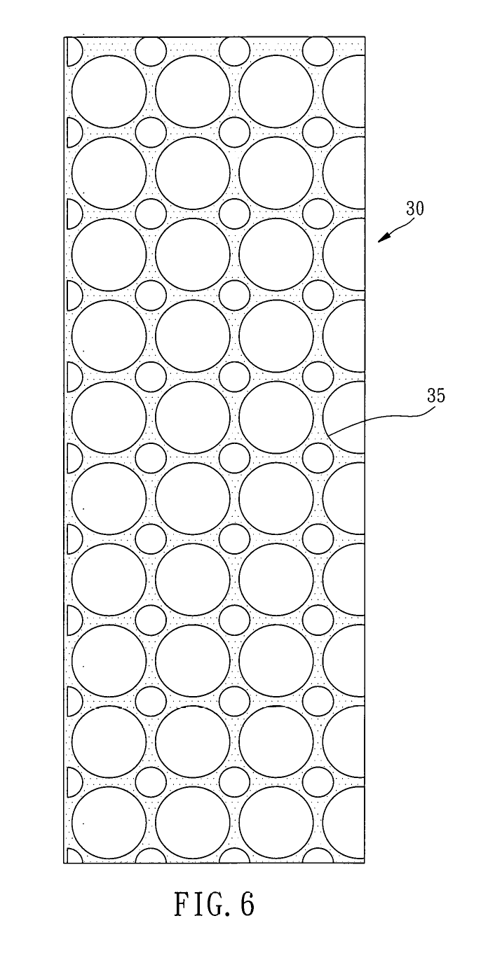

Referring to FIG. 6, a sporting towel mat 30 having an anti-slip strip 35 according to a third preferred embodiment of the present invention is similar to the sporting towel mat 10 of the first preferred embodiment, but differs from the sporting towel mat 10 in that described below.

The anti-slip strip 35 has multiple widths.

The anti-slip strip 35 with multiple widths can form various patterns to provide various visual effects, thereby increasing the user's purchase intention.

Other structures and effects of the third preferred embodiment are the same as that of the first preferred embodiment, so their detailed descriptions are omitted.

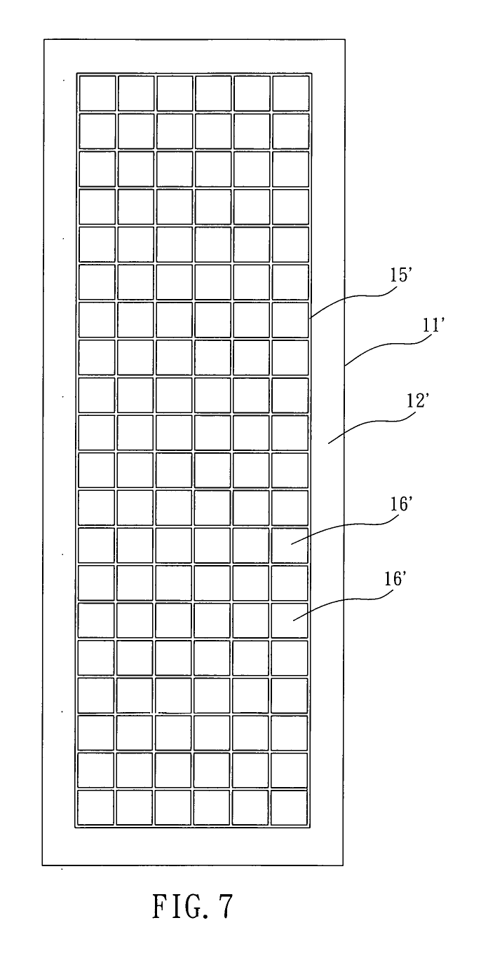

It should be complementarily explained that, apart from the types of the anti-slip strip disclosed in the aforesaid three embodiments, the anti-slip strip 15′ (as shown in FIG. 7) can be interlaced to form a plurality of intersections and fully distributed on the first surface 12′ of the fabric towel 11′ in a way that the at least one exposed part 16′ and the anti-slip strip 15′ are both included in any area equal to the area of the human palm excluding all fingers on the first surface 12′ of the fabric towel 11′.

It also should be complementarily explained that, the anti-slip strip 15 in the aforesaid three embodiments can be shaped in another form that the middle part is higher than the two side parts on the surface of the anti-slip strip, and still has a stereoscopic structure, thereby having a relatively larger surface. Such structure is easily understood, so it is not illustrated in the figures.

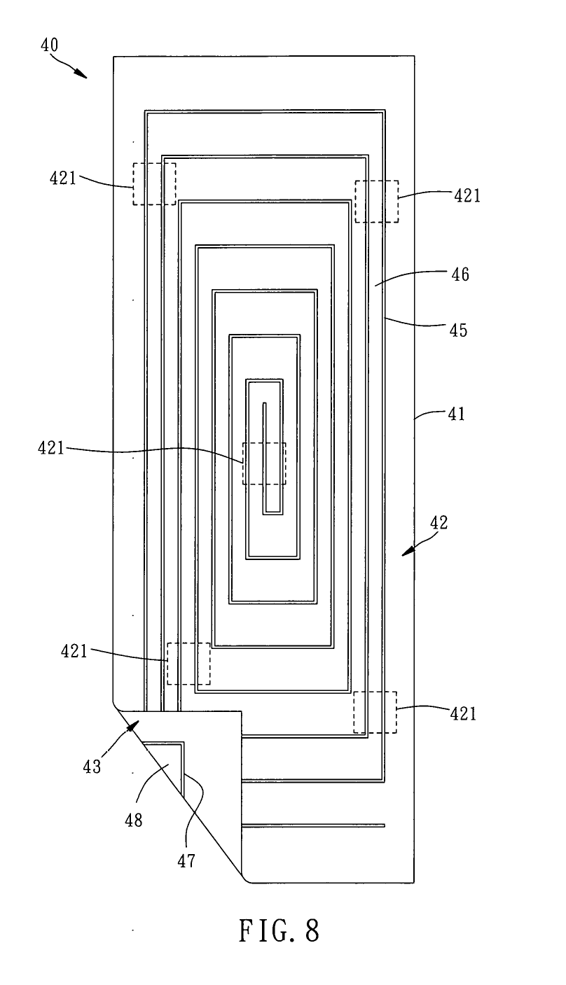

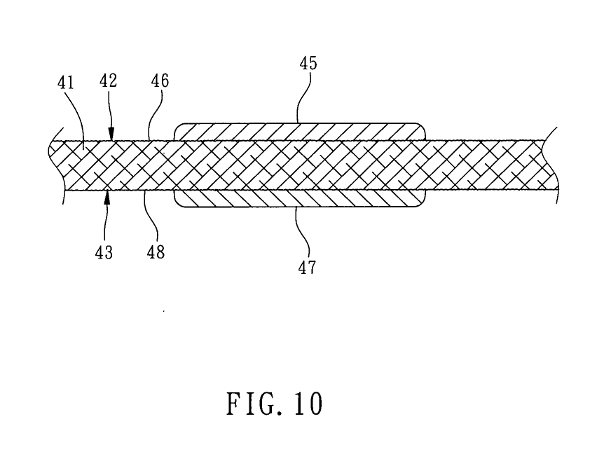

Referring to FIGS. 8-10, a sporting towel mat 40 in accordance with a fourth embodiment of the present invention is shown. The sporting towel mat 40 comprises a fabric towel 41, only one single first anti-slip strip 45 and only one single second anti-slip strip 47.

The fabric towel 41 defines a first surface 42 and an opposing second surface 43.

The first anti-slip strip 45 is a one-piece member in a continuous form attached on the first surface 42 of the fabric towel 41 to form a predetermined pattern which covers the first surface 42 of the fabric towel 41 incompletely, so that the first surface 42 of the fabric towel 41 defines a first exposed part 46 that is not covered by the anti-slip strip 45.

The second anti-slip strip 47 is a one-piece member in a continuous form attached on the second surface 43 of the fabric towel 41 to form a predetermined pattern which covers the first surface 43 of the fabric towel 41 incompletely, so that the first surface 43 of the fabric towel 41 defines a second exposed part 48 that is not covered by the anti-slip strip 45.

The fabric towel 41 can be folded up with the first anti-slip strip 45 and the second anti-slip strip 47, facilitating storage.

The second surface 43 contacts a support surface (not shown). The first surface 42 is adapted for the contact of the human body. In actual application, the support surface can be the ground, or can be any other mat such as floor mat or yoga mat. When the first surface 42 contacts a human body, the surface of the first anti-slip strip 45 and the surface of the fabric towel 41 can contact the human body.

The first surface 42 of the fabric towel 41 defines a plurality of first partial section 421. Each first partial section 421 has a first surface area. The first exposed part 46 and the first anti-slip strip 45 are partially included in each first partial section 421. Further, the second surface 43 of the fabric towel 41 defines a plurality of second partial sections 431. Each the second partial section 431 has a second surface area [symbol] Further, the second exposed part 48 and the second anti-slip strip 47 are partially included in the second partial section 431.

The area size of the first surface area of each first partial section 421 and the area size of the second surface area of each second partial section 431 are in the range of 200˜50 cm². The area size definition of the first partial section 421 and the second partial section 431 is mainly based on the fact that the surface of the fabric towel 41 and the first anti-slip strip 45 or second anti-slip strip 47 can be simultaneously contacted when the user is in contact within this area. Because the palm and sole of an adult is generally within this area, it is ensured that the human body can simultaneously contact the surface of the fabric towel 41 and the first anti-slip strip 45 or second anti-slip strip 47. In this way, if the user's body surface is not sweaty, then the surface of the fabric towel 41 is slippery relative to the human body surface, but the first anti-slip strip 45 or the second anti-slip strip 47 can provide an anti-slip effect to the human body without sweat. If the user's body surface is sweaty due to sweating, then the fabric towel 41 can absorb sweat and produce a slip-proof effect on the human body surface, but the first anti-slip strip 45 or the second anti-slip strip 47 will become slippery due to sweat. Therefore, in the first partial section 421 and the second partial section 431, within this area size, the anti-slip effect can be provided on the surface of the human body with or without sweat.

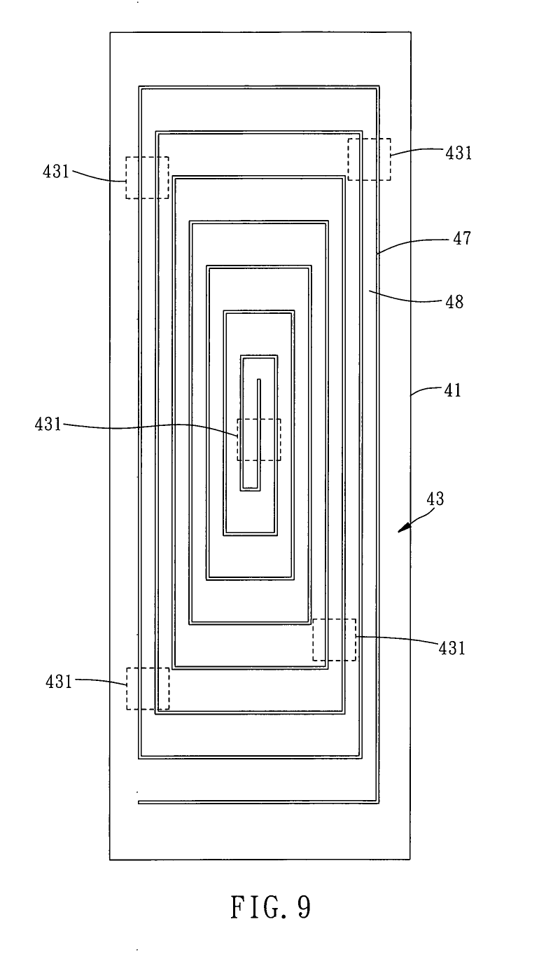

In this fourth embodiment, the first anti-slip strip 45 and the second anti-slip strip 47 are single lines and not interlaced. Further, the first anti-slip strip 45 and the second anti-slip strip 47 are corresponding to each other through the fabric towel 41, so that the predetermined patterns formed by the first anti-slip strip 45 and the second anti-slip strip 47 are mutually mirror-like. FIG. 9 illustrates the pattern of the second anti-slip strip 47 that exhibits a mirror-like relationship with the pattern of the first anti-slip strip 45 shown in FIG. 8.

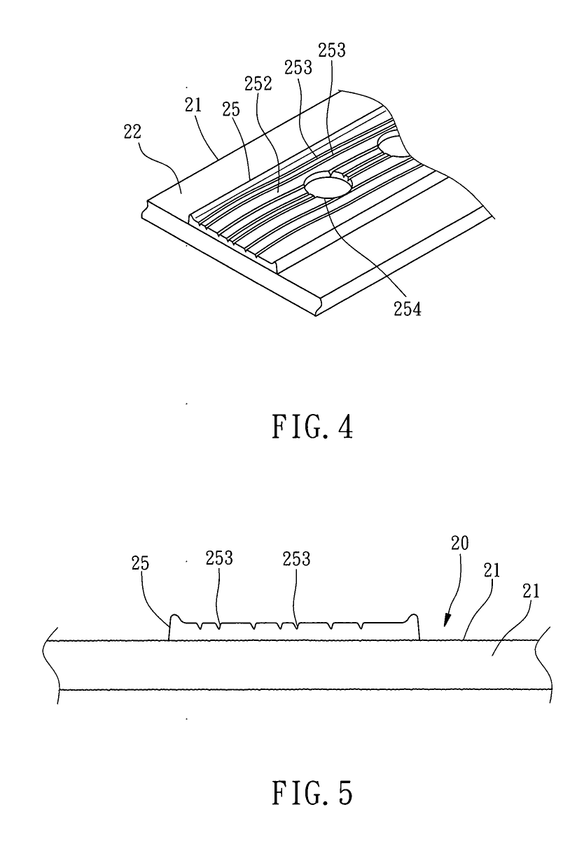

The surface of the first anti-slip strip 45 and the second anti-slip strip 47 may be flat or uneven in cross section. The unevenness may be provided with a plurality of concave lines on the surfaces of the first anti-slip strip 45 and the second anti-slip strip 47, and the concave lines are used to form concave portions of the unevenness, which is shown in FIG. 4 and we will not repeat them here.

In addition, the first anti-slip strip 45 and the second anti-slip strip 47 can also be self-interlaced to form a plurality of intersections. This has been illustrated in FIG. 1 and in the first embodiment. Further, the widths of the first anti-slip strip 45 and the second anti-slip strip 47 may also be uniform or non-uniform, as disclosed in the first and third embodiments corresponding to FIGS. 1 and 6 of the present disclosure. Further, the first anti-slip strip 45 and the second anti-slip strip 47 can be configured to provide a plurality of openings through which the fabric towel 41 is exposed to the outside. This feature has also been disclosed in FIG. 4 and the second embodiment. Further, the primary constituent of the first anti-slip strip 45 and the second anti-slip strip 47 is silicone rubber.

In comparison with conventional sporting towel mat which has anti-slip projections attached in a discontinuous pattern, the way of the present invention that the first anti-slip strip 45 and second anti-slip strip 47 being continuously attached on the fabric towel 41 helps the anti-slip strips 45,47 from being detached from the fabric towel 41 due to the relationship of connection.

What is claimed is:

1. A sporting towel mat for use on a support surface, comprising:
a fabric towel defining a first surface and an opposing second surface;
only one single first anti-slip strip having a predetermined width and being continuously attached on said first surface of said fabric towel to form a predetermined pattern that covers said first surface of said fabric towel incompletely so that said first surface of said fabric towel has at least one part thereof exposed to the outside of said first anti-slip strip to define at least one first exposed part;
only one single second anti-slip strip having a predetermined width and being continuously attached on said second surface of said fabric towel to form a predetermined pattern that covers said second surface of said fabric towel incompletely so that said second surface of said fabric towel has at least one part thereof exposed to the outside of said second anti-slip strip to define at least one second exposed part;
wherein:
said fabric towel is foldable with said first anti-slip strip and said second anti-slip strip;
one of said, first surface and said second surface is adapted for contacting a support surface, and the other of said first surface and said second surface and the attached said first anti-slip strip or said second anti-slip strip are adapted for the contact of the human body;
said first surface of said fabric towel defines a plurality of first partial sections, each said first partial section having a first surface area, said at least one first exposed part and said first anti-slip strip being partially included in each said first partial section;
said second surface of said fabric towel defines a plurality of second partial sections, each said second partial section having a second surface area, said at least one second exposed part and said second anti-slip strip being included in each said second partial section;
the area size of each said first surface area and each said second surface area is in the range of 200˜50 cm².

2. The sporting towel mat for use on a support surface as claimed in claim 5, wherein the surface of said first anti-slip strip and the surface of said second anti-slip strip are concave and convex in cross section.

3. The sporting towel mat for use on a support surface as claimed in claim 2, wherein said first anti-slip strip and said second anti-slip strip each comprise a plurality of concave lines, said concave lines forming the concave portion of the concave and convex configuration in cross section.

4. The sporting towel mat for use on a support surface as claimed in claim 1, wherein the primary constituent of said first anti-slip strip and said second anti-slip strip is silicone rubber.

5. The sporting towel mat for use on a support surface as claimed in claim 1, wherein at least one of said first anti-slip strip and said second anti-slip strip is made in the form of a single line having no interlace.

6. The sporting towel mat for use on a support surface as claimed in claim 1, wherein at least one of said first anti-slip strip and said second anti-slip strip is interlaced to form a plurality of intersections.

7. The sporting towel mat for use on a support surface as claimed in claim 1, wherein at least one of said first anti-slip strip and said second anti-slip strip has a uniform width.

8. The sporting towel mat for use on a support surface as claimed in claim 5, wherein at least one of said first anti-slip strip and said second anti-slip strip has multiple widths.

9. The sporting towel mat for use on a support surface as claimed in claim 1, wherein at least one of said first anti-slip strip and said second anti-slip strip comprises a plurality of openings to expose said fabric towel.

10. The sporting towel mat for use on a support surface as claimed in claim 1, wherein said first anti-slip strip and said second anti-slip strip are corresponding to each other through said fabric towel, so that the predetermined patterns formed by said first anti-slip strip and said second anti-slip strip are mutually mirror-like.
